(19) United States
(12) Patent Application Publication
(10) Pub. No.: US 2018/0231648 A1
(43) Pub. Date: Aug. 16, 2018

(54) SYSTEM AND METHOD TO MEASURE UE-TO-UE DISTANCE BASED ON D2D SIDELINK CHANNEL

(71) Applicant: ZTE CORPORATION, Shenzhen (CN)

(72) Inventor: Wenfeng ZHANG, Plano, TX (US)

(21) Appl. No.: 15/750,275

(22) PCT Filed: Aug. 8, 2016
(86) PCT No.: PCT/US2016/045983

§ 371 Date: Feb. 5, 2018

Related U.S. Application Data
(60) Provisional application No. 62/202,666, filed on Aug. 7, 2015.

(51) Int. Cl. G01S 11/08; G01S 13/76; H04W 64/00

(52) U.S. Cl. CPC G01S 11/08; H04W 76/14; H04W 64/003; G01S 13/76

(57) ABSTRACT

New method for measuring UE-to-UE distance based on D2D sidelink channel or signal. The network configures the two UEs to perform both transmission and reception of D2D sidelink channel or signal; the UEs determine in time domain the cycle boundaries of the same cycle duration and use the cycle boundaries as the timing references to measure transmission timing and receiving timing; each UE reports to network one transmission timing and one or more receiving timings, or one or more modulo transmission-to-reception time differences; each UE reports to network one transmission identity associated with transmitted D2D sidelink channel or signal and one or more transmission identities each of which associated with a received D2D sidelink channel or signal; the network obtaining the reports from the two UEs matches the timing information based on the associated transmission identities and calculates the UE-to-UE distance based on the matched timing information.

### TECHNICAL FIELD

The present application is directed to a new method to use the device-to-device (D2D) sidelink channel or signal to obtain the UE-to-UE distance in mobile positioning. The present application has a specific application but not limited to the mobile positioning in 3GPP Long Term Evolution (LTE) system that is one of the candidates for the 4-th generation wireless system.

### BACKGROUND

The location based services (LCS) brought great convenience and new services to subscribers of mobile communication networks and generated significant revenues to the operators. The fundamental technology supporting LCS is mobile terminal positioning. There were several mobile positioning techniques discussed in 3GPP standard body. Among them, Time-difference-of-Arrival (TDOA) based solution is mostly well studied. For example, the TDOA technique based on timing measurements upon specific downlink signal, positioning reference signal (PRS), is specified in E-UTRAN LTE release 9 and is usually named Observed-Time-difference-of-Arrival (OTDOA); the TDOA technique based on timing measurements upon specific uplink signal, sounding reference signal (SRS), is specified in E-UTRAN LTE release 10 and is usually named Uplink-Time-difference-of-Arrival (UTDOA).

In the existing TDOA-based positioning solution and some other positioning solutions, the network configures user equipment (UE) with the assistance information data, which helps the UE to measure the downlink signals transmitted from the network nodes and/or to transmit the uplink signals to the network nodes for measurement. The measurement results for this target UE are collected at one network node, for example, the positioning server, to calculate the position of the target UE. In the existing mobile positioning solution, besides the network nodes, the only UE involved in the positioning of target UE is the target UE itself.

Within the LTE release 13, the study to enhance the indoor positioning, which aims to achieve higher positioning accuracy on both horizontal and vertical directions, reveals that one specific deployment of base stations or so-called eNBs, which is named “small cell deployment”, can improve the indoor positioning performance (ref. 3GPP TR37.857 Indoor Positioning Enhancement). In the small cell deployment, the mobile network operator places small cell base stations or so-called “small cell eNBs” with the eNB density much larger than that of traditional cellular cell, so that the traffic serving capability such as the overall traffic throughput per geographical area is dramatically increased. From the concern of UE positioning, the small cell deployment shortens the distance between the UE and the nearby eNBs. Given the same level of range measurement accuracy, the positioning error can be reduced if the positioning is based on the geometry with smaller UE-to-eNB distances.

The positioning improvement mentioned above relies on the shorter UE-to-eNB distance, and therefore is not available in the cellular areas where small cell is not deployed or the small cell coverage is not “small” enough. If people considers the UE positioning as a general geometry locating problem involving the target UE and a number of assisting geographical nodes, those assisting geographical nodes can not only come from the network nodes as mentioned above for the existing positioning solutions, but may also be the other UEs as long as the distance between each of these assisting UEs and the target UE is measurable. In other words, the UE positioning solution using the UE-to-UE distance measurements can provide the potential accuracy improvement whether or not the small cell deployment is available. It should be noted that, because the location of the assisting UE is generally unknown, the positioning of the target UE cannot be determined only based on UE-to-UE distance measurements. The UE-to-UE distance measurement should be used together with traditional positioning solution, which involves the UE-to-eNB distances, such as OTDOA and UTDOA.

For better accuracy, the UE-to-UE distance measurement should be based on the timing measurements of the signals transmitted between the two involved UEs. In 3GPP LTE, the signals transmitted between two UEs are specified as device-to-device (D2D) sidelink channels and signals, which include Physical Sidelink Shared Channel (PSSCH), Physical Sidelink Control Channel (PSCCH), Physical Sidelink Discovery Channel (PSDCH), Physical Sidelink Broadcast Channel (PSBCH) and Sidelink Synchronization Signal (ref. 3GPP TS36.211, v12.6.0). Each transmission unit for the above sidelink channels occupies one subframe duration, i.e. one millisecond, in the time domain. According to 3GPP technical report for D2D (ref 3GPP TR36.877, v12.0.0), D2D applications up to LTE release 12 have two scenarios including general scenario and public safety scenario, and two usages including D2D discovery and D2D broadcast communication, where D2D discovery is the only usage that can be applied in a scenario other than public safety. Because it is generally desired to be able to apply UE positioning functionality for non-public-safety purpose, the following invention is described by assuming that the D2D sidelink discovery channel, i.e. PSDCH, is used in D2D-assisting positioning. However, most of principles mentioned in the present application are also applicable to other D2D sidelink channels or signals if they are used in future LTE release for general D2D (non-public-safety) scenario.

### BRIEF DESCRIPTION OF THE DRAWINGS

FIG. 1 depicts the timings of a series of PSDCH transmissions and receptions between two UEs according to some embodiments of the present application.

FIG. 2 depicts the timings of PSDCH transmissions and receptions that are used to calculate UE-to-UE distance according to some embodiments of the present application.

FIG. 3 depicts a wireless telecommunication system for measuring UE-to-UE distance based on D2D sidelink channel or signal according to some embodiments of the present application.

### DETAILED DESCRIPTION

The present application is directed to a method to measure the transmission timings and receiving timings of one specific D2D sidelink channel or signal between two UEs to derive the device-to-device or UE-to-UE distance. Although the method is illustrated for mobile positioning in 3GPP LTE system, the same principle can be used in other positioning system based on the geometry distance measurements.

These and other implementations and examples of the present application in software and hardware are described in greater details below.

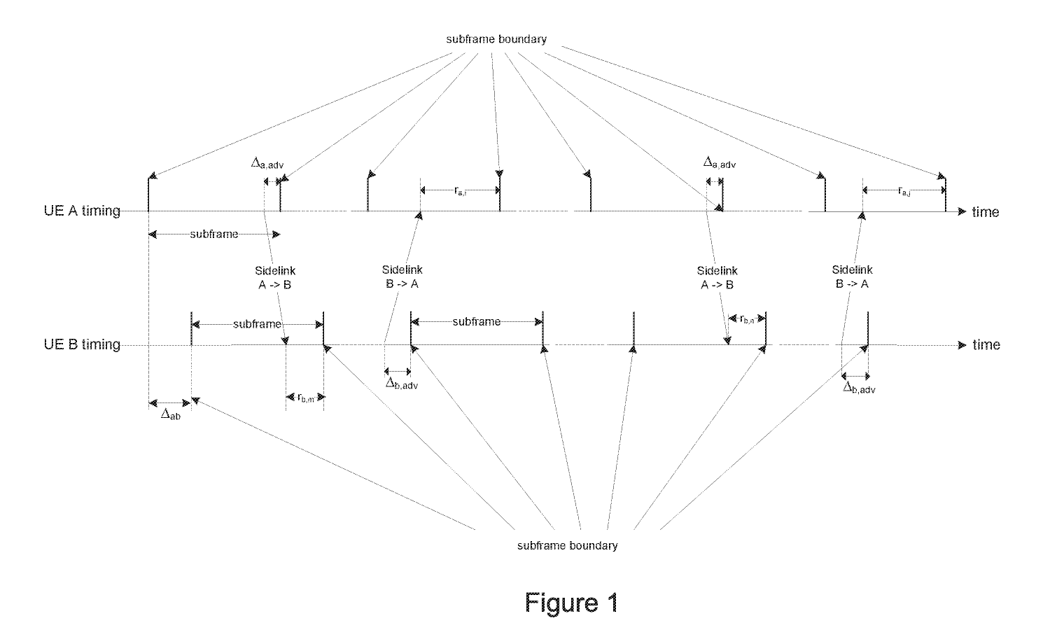

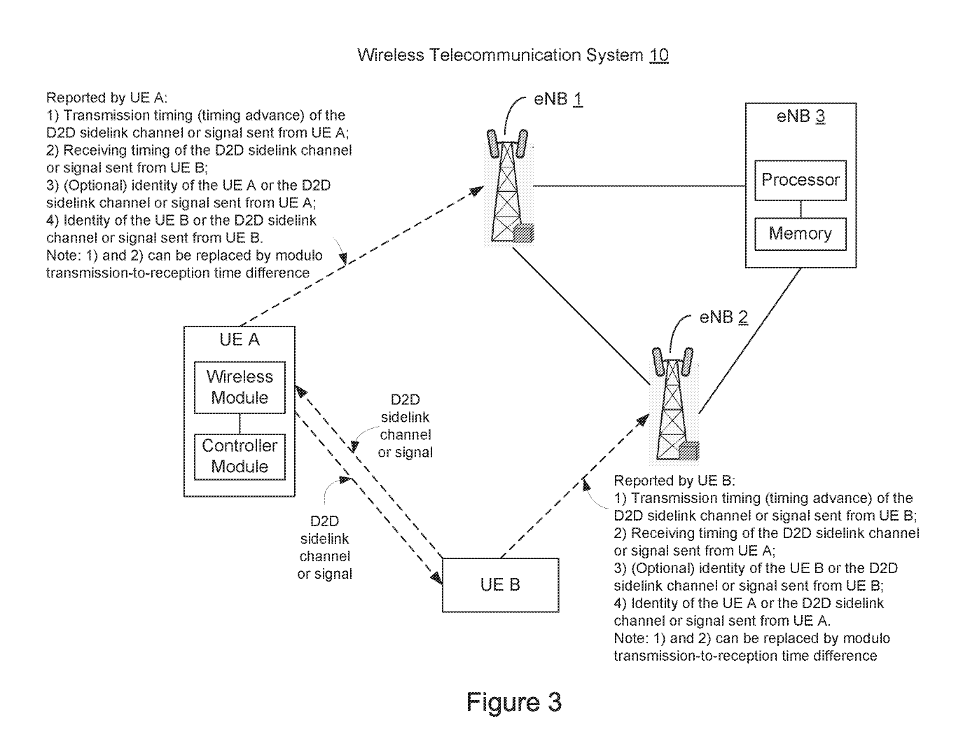

For example, FIG. 3 depicts a wireless telecommunication system 10 for measuring UE-to-UE distance based on D2D sidelink channel or signal according to some embodiments of the present application. The wireless telecommunication system 10 includes one or multiple eNBs (e.g., eNB 1, eNB 2, and eNB 3), which are communicatively connected to each other via wired or wireless channels. At least one of the eNBs (e.g., eNB 3) includes a processor and memory for performing the inventions disclosed in the present application. It should be noted that the term “eNB” and “network node” are used interchangeably in the present application. In this example, two D2D-capable UEs, UE A and UE B, are configured to communicate with the network nodes eNB 1 and eNB 2, respectively, via one or more wireless channels. In some embodiments, each UE includes a wireless module and a controller module to support the communication with the respective eNB. Although it is assumed that the two D2D-capable UEs in FIG. 3, UE A and UE B, are generally not timing-aligned with each other because they may be synchronized to different serving eNBs, one skilled in the art would understand that the inventions disclosed in the present application work regardless of whether the two UEs are communicating with the same or different eNBs. In this example, the subframe timing difference between these two UEs, which is defined as Δ_{ab} in FIG. 1, is not measurable and therefore is unknown by either UE or the network. The transmissions of PSDCH on each side of UEs are independent from each other. This property differentiates the present application from existing positioning solutions, where there is inter-dependency between the transmissions by a UE and another UE or network node (ref. 3GPP TDoc R1-151446, “Discussion on Potential Enhancement of Positioning Techniques”, Intel). In addition, each single transmission of PSDCH is subjected to a run-time probability, i.e. the network only configures the resource and opportunity of PSDCH transmission for a UE, but it is that UE's run-time decision whether or not to actually transmit a PSDCH signal for each transmission opportunity at the configured resource. Therefore the time duration between the PSDCH transmission by one UE and the reception of another UE's PSDCH by the same UE is uncoordinated and unpredictable. This property additionally differentiates the present application from other existing positioning solutions, where the transmission-to-reception interval (referred to as “Rx-Tx time difference”) at a single UE or eNB is measured and reported for positioning calculation (ref 3GPP TS 36.214, v10.1.0).

As shown in FIG. 1, each UE may transmit a series of PSDCH, without knowing that each transmitted PSDCH is successfully received by which of other UEs. The transmission of PSDCH by each UE may be subjected to a timing advance, i.e. Δ_{a,adv} for UE A and Δ_{b,adv} for UE B in the FIG. 1, which indicates the starting timing of PSDCH transmission ahead of starting timing of the next subframe. The timing advance value for a UE is constant for the series transmissions of PSDCH, but can be different from UE to UE. For the PSDCH that is successfully received by one UE, the receiving timing of PSDCH is measured and represented as the time interval between the instance of first PSDCH sample reception and the next subframe boundary according to the timing of receiving UE. This is shown in FIG. 1 as rₐ for UE A and r_{b} for UE B. Such measured receiving timing is usually varying among different PSDCH receptions even for the same transmitting UE, because of measurement error, multipath variation and etc. The UE receiving the PSDCH can determine its receiving timing to be reported by either measuring the receiving timing of one specific PSDCH reception or averaging the measured receiving timings of multiple PSDCH receptions that are sent from the same UE. In the following description, rₐ and r_{b} are denoted as receiving timings determined by the respective receiving UEs for the report.

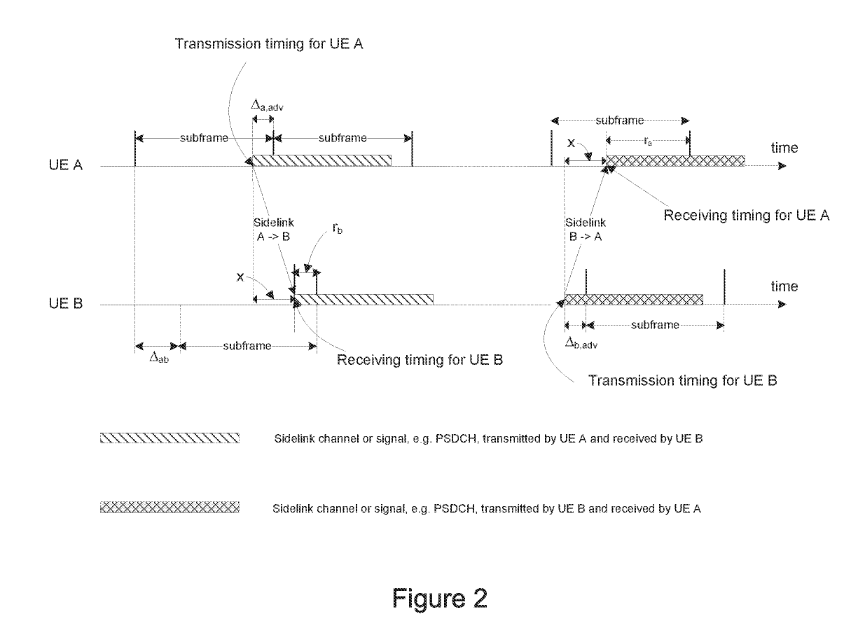

As far as timing measurement is concerned, the series of PSDCH transmissions and receptions between two UEs can be abstracted as two independent transmission-reception procedures as shown in FIG. 2. Denote the subframe duration as T_{SF} and the one-way propagation time between the two UEs as x. Then, the two transmission-reception procedures in FIG. 2 can give the following set of equations:

$$\{ \begin{matrix}( - {Δ}_{a , adv} + x + {r}_{b} - {Δ}_{ab} ) mod {T}_{SF} = 0 \\ ( - {Δ}_{b , adv} + x + {r}_{a} + {Δ}_{ab} ) mod {T}_{SF} = 0\end{matrix} \qquad ( equation 1 )$$

where “mod” indicates the modulo operation. From this pair of equations, x can be derived as

$$x = \frac{1}{2} ( {Δ}_{a , adv} + {Δ}_{b , adv} - {r}_{a} - {r}_{b} + k \cdot {T}_{SF} ) \qquad ( equation 2 )$$

where k is an integer. Because T_{SF}/2=0.5 ms corresponds to propagation distance of 150 km, which is far larger than the possible UE-to-UE distance for D2D discovery and communication, k should be chosen (e.g., zero) such that 0≤x<0.5T_{SF}. Once the value of x is obtained, the UE-to-UE distance can be derived as c·x, where c is speed of light.

According to the equation 2, if the subframe boundary for the UE A (or UE B) is delayed by an amount of ε, both the timing advance Δ_{a,adv} (or Δ_{b,adv}) and the receiving timing rₐ (or r_{b}) are increased by ε, which cancel each other and make x unchanged. The same property is still true if the subframe boundary is advanced rather than delayed. That is to say, each UE can choose its own definition of “subframe boundary” in FIG. 1 and FIG. 2 to measure the timing advance for PSDCH transmission and receiving timing for PSDCH reception. It should be noted that, even though the present application is described assuming that the timing advance and the receiving timing are represented as the time intervals between the corresponding transmission/reception instances and the next subframe boundary, the principle of the present application remains the same if the two timings are represented as the time intervals between the corresponding transmission/reception instances and the previous subframe boundary according to the timing of receiving UE. In that case, the equation 2 should be modified as:

$$x = \frac{1}{2} ( {r}_{a} + {r}_{b} - {Δ}_{a , adv} - {Δ}_{b , adv} + k \cdot {T}_{SF} ) \qquad ( equation 3 )$$

The definition of timing advance and reception timing can also be changed to represent the time intervals on two different sides of subframe boundary, which requires the equation 2 to be changed accordingly.

Note that the subframe duration T_{SF} solves the ambiguity issue in the determination of x by preserving the value of T_{SF} to be larger than the two times of largest propagation time between any two UEs in D2D discovery and communication. Besides solving this ambiguity issue, subframe duration T_{SF} does not impact solution of x. That is to say, the subframe duration in FIG. 1 and FIG. 2 can be replaced by another different periodic cycle duration, as long as the new cycle duration is larger than the two times of largest propagation time between any two UEs in D2D discovery and communication provided that the two involved UEs use the same cycle duration.

In some embodiments, equation 2 can be reformulated as:

$$x = \frac{1}{2} \{ [ ( {Δ}_{a , adv} - {r}_{a} ) mod {T}_{SF} ] + [ ( {Δ}_{b , adv} - {r}_{b} ) mod {T}_{SF} ] + k \cdot {T}_{SF} \} \qquad ( equation 4 )$$

where (Δ_{a,adv}−rₐ)mod T_{SF} and (Δ_{b,adv}−r_{b})mod T_{SF} are the modulo transmission-to-reception time differences for UE A and UE B, respectively. In general, the modulo transmission-to-reception time difference referred in this application equals to the difference between the transmission timing of a sidelink channel transmission at a UE and the receiving timing of sidelink channel reception at the same UE, where this time difference is further calculated in modulo operation with the modulo divisor to be larger than the two times of largest propagation time between any two UEs in D2D discovery and communication. One of the reasons to apply the modulo operation to transmission-to-reception time difference comes from the fact that the transmission timing and receiving timing at one UE's end are non-coordinated and non-predictable. Without modulo operation, the recorded transmission-to-reception time difference can be very large and consume unnecessary payload information bits in the report.

It is assumed in the present application that the calculation of UE-to-UE distance is done on network side. According to the above description, each involved UE needs to report the necessary timing measurements, which can have two alternatives:
Alternative 1: Transmission timing (e.g., timing advances Δ_{a,adv} or Δ_{b,adv} in the above description) and receiving timing are individually reported to the network, where the two timings are measured with respect to the cycle boundaries based on the same cycle duration.
Alternative 2: What each UE reports is the modulo transmission-to-reception time difference as described in equation 4 above instead of the transmission timing and receiving timing.
   Note that the two alternatives have the same effect if the cycle duration in alternative 1 equals to the modulo divisor in alternative 2.

Because one particular UE may receive multiple PSDCH signals from different UEs and submit multiple reports to the network for the different UE-to-UE distance calculations, certain additional information should be provided to the mentioned network node in order to identify the right pair of UE reports from those numerous reports and to put those reported parameters together as in equation 1 or 2 for the right pair of UEs. However, one issue arises when it comes to the PSDCH, because PSDCH itself in the current LTE specifications does not carry the information to identify the transmitting UE. For example, what UE A (or UE B) in FIG. 2 currently reports to the network node is “the receiving timing of PSDCH transmitted by certain unknown UE”, rather than “the receiving timing of PSDCH transmitted by UE B (or UE A)”. Therefore the network node may need additional information to determine either the identity of the transmitting UE or the identity of the transmitted PSDCH when it receives multiple receiving timings or modulo transmission-to-reception time differences from a UE. The identity of the transmitted PSDCH would eventually identify the transmitter if the identity of the transmitted PSDCH is unique among all PSDCH transmitted from all transmitters.

One way for the network node to identify the transmitter is to simply add the transmitter identity or the PSDCH identity to the PSDCH payload, so that the UE receiving the PSDCH can retrieve the identity and report it to the network together with the receiving timing or modulo transmission-to-reception time difference. However, the payload size of PSDCH is limited, so it is uncertain whether there is enough room to add the transmitter identity into PSDCH. In addition, the PSDCH payload is defined out of scope of 3GPP Radio Access Network (RAN), while the mobile positioning where the UE-to-UE distance measurement is usually applied is a functionality currently specified inside RAN scope. Therefore it is not an ideal solution to have UE-to-UE distance measurement based on PSDCH payload content, which is specified outside RAN scope.

The second solution for the network to identify the transmitter is to make certain PSDCH transmission property of a transmitting UE unique from the PSDCH transmission property of other transmitting UEs, and to use that unique transmission property to identify the PSDCH transmitter or the transmitted PSDCH. In other words, that unique transmission property becomes a transmission identity or the equivalent. For example, for a UE involved in the D2D-assisting positioning, it can be assigned by the network node with a discovery resource or resource pool that is not overlapping with the discovery resources or resource pools assigned to other D2D UEs. The uniqueness of such resource assignment can be realized by adopting appropriate values for the following parameters in the Radio Resource Control (RRC) Information Element (IE) SL-DiscConfig (ref. TS36.331, v12.6.0):
Time domain parameters: offsetIndicator-r12, discPeriod-r12, subframeBitmap-r12. These parameters are currently specified to indicate all the potential subframe candidates that can be used to transmit PSDCH.
Frequency domain parameters: prb-Start-r12, prb-End-r12 and prb-Num-r12. These parameters are currently specified to indicate all the potential physical resource block (PRB) candidates that can be used to transmit PSDCH.
   If one UE is needed to join in D2D-assisting positioning, the network can assign OFDM resources to this UE for its PSDCH transmission such that the assigned resources are not overlapping with the PSDCH resources of other D2D UEs in time domain or frequency domain or even both. In order to allow the network node in charge of UE-to-UE distance calculation to identify the PSDCH transmitter, the UE transmitting the PSDCH reports to the network node the configured RRC IE SL-DiscConfig or a part of it (e.g., only the time-domain and/or frequency-domain parameters listed above), which directs the transmitting UE where and how to transmit the PSDCH; and the UE successfully receiving the PSDCH reports to the network node the configured RRC IE SL-DiscConfig or a part of it, which directs the receiving UE where and how to receive the PSDCH. In some embodiments, the network node can also attach a resource identification number to the configured RRC IE SL-DiscConfig so that the UE does not need to report the lengthy RRC IE but only the resource identification number.

With the techniques described above, the UE-to-UE distance measurement based on D2D sidelink channel or signal X (X can be chosen from PSDCH, PSSCH and etc) can be described as following:

For the pair of two UEs (e.g., UE A and UE B shown in FIG. 3) that have D2D capability, the network (e.g., the network node 3) configures each of the two UEs to transmit and receive the D2D sidelink channel or signal X. If the D2D sidelink channel or signal X does not provide information to identify the transmitting UE or the transmitted sidelink channel or signal X, the network should configure each of two UEs with the unique configuration relating to transmission of D2D sidelink channel or signal X via UE-specific RRC signaling, where the unique configuration means that the configuration for each of the two UEs is uniquely identifiable from any of configurations for the transmissions of D2D sidelink channel or signal X performed by any of other UEs, no matter whether the other UEs are involved in the UE-to-UE distance calculation. One example of such unique configuration is the configuration of OFDM resources over time domain and/or frequency domain within which the D2D sidelink channel or signal X can be transmitted by the configured UEs. The configured resource can be associated with a resource identification number.

For each UE configured to transmit and receive the D2D sidelink channel or signal X for UE-to-UE distance calculation purpose, the UE determines the periodic cycle boundaries in time domain, where the cycle durations between any two adjacent boundaries at each UE are the same and the cycle durations among different UEs are also the same. Some examples of such periodic cycle setup can be based on the radio subframe according to UE's local timing, where the cycle duration equals to m subframes, with m to be chosen from but not limited to 0.5, 1, 2, . . . , 10 and etc.

With the periodic cycle boundaries determined, the UE transmits the D2D sidelink channel or signal X. According to the standard specification for D2D, the transmission of D2D sidelink channel or signal X may be subjected to a timing advance. Here the timing advance in the present application is represented as the time interval between the time instance of transmission of D2D sidelink channel or signal X and the next cycle boundary (i.e. the first cycle boundary after the transmission instance). The UE should report to the network node the value of this timing advance. The UE should also report to the network node the identity of either the transmitter UE or the sidelink channel or signal X that is transmitted. In some cases, such identity does not need to be explicitly contained in the report; instead, it can be implicitly indicated by the report, e.g. the originator of the report is certainly the transmitter UE itself, and the report originator is known to the network node according to higher-layer signaling protocol carrying that report. If the D2D sidelink channel or signal X does not provide the information to identify the transmitting UE or the transmitted sidelink channel or signal X, the UE transmitting the D2D sidelink channel or signal X may need to report to the network node the RRC configuration relating to transmission of D2D sidelink channel or signal X, e.g. the configured OFDM resources or the resource identification number associated with the configured OFDM resources used for the corresponding transmission.

With the periodic cycle boundaries determined, the UE receiving the D2D sidelink channel or signal X according to the configuration measures the receiving timing, which is represented as the time interval between the time instance at which the D2D sidelink channel or signal X is received and the next cycle boundary (i.e. the first cycle boundary after the time instance of receiving the D2D sidelink channel or signal X). The UE should report to the network node the value of this receiving timing. The UE should also report to the network node the information of transmitter's identity that is derived from the received D2D sidelink channel or signal X. If the D2D sidelink channel or signal X does not provide the information to identify the transmitting UE, the receiving UE may need to report to the network the RRC configuration, according to which the D2D sidelink channel or signal X is received. One example of such RRC configuration information is the configured OFDM resources or the resource identification number associated with the configured OFDM resources. The network then determines the identity of the transmitting UE based on the uniqueness of the RRC configuration.

In some embodiments, instead of reporting both timing advance (i.e. transmission timing) and receiving timing, the UE may report to the network node the modulo transmission-to-reception time difference, which equals to the difference between transmission timing and receiving timing with the modulo divisor equal to the cycle duration as defined in equation 4 above.

According to the above description, the reports sent to the network from a single UE include following:
One transmission identity (either explicit or implicit) identifying the sidelink channel or signal X that is transmitted by the reporting UE; one or more transmission identities, each of which identifies the sidelink channel or signal X that is transmitted by a different UE and received by the reporting UE.
Timing information in one of the following two alternatives:
   Alternative 1: One timing advance for the sidelink channel or signal X that is transmitted by the reporting UE and one or more receiving timings, each of which associates with the sidelink channel or signal X that is transmitted by a different UE and received by the reporting UE;
   Alternative 2: one or more modulo transmission-to-reception time differences, each of which associates with the sidelink channel or signal X that is transmitted by a different UE and received by the reporting UE.

In some embodiments, for the two UEs between which the distance is to be calculated, each needs to successfully receive the sidelink channel or signal X from the other and report the information listed above to the network node the following:
The first transmission identity(=a) for the sidelink channel or signal X that is transmitted by the first UE (e.g., UE A in FIG. 3) and received by the second UE (e.g., UE B in FIG. 3); the second transmission identity(=b) for the sidelink channel or signal X that is transmitted by the second UE and received by the first UE;
One of the following two alternatives for timing information:
   Alternative 1: the first timing advance(=Δ_{a,adv}) reported by the first UE; the second timing advance(=Δ_{b,adv}) reported by the second UE; the first receiving timing(=rₐ) reported by the first UE and associated with the received sidelink channel or signal X of the second transmission identity(=b); the second receiving timing(=r_{b}) reported by the second UE and associated with the received sidelink channel or signal X of the first transmission identity(=a).
   Alternative 2: the first modulo transmission-to-reception time difference (=(Δ_{a,adv}−rₐ)mod T_{SF}) reported by the first UE and associated with the received sidelink channel or signal X of the second transmission identity(=b); the second modulo transmission-to-reception time difference (=(Δ_{b,adv}−r_{b})mod T_{SF}) reported by the second UE and associated with the received sidelink channel or signal X of the first transmission identity(=a).
      Then the network node can calculate the UE-to-UE distance (denoted as d) by bringing the parameters contained in the above reports into

$$d = \frac{c}{2} ( {Δ}_{a , adv} + {Δ}_{b , adv} - {r}_{a} - {r}_{b} + k \cdot {T}_{SF} ) or$$

$$d = \frac{c}{2} \{ [ ( {Δ}_{a , adv} - {r}_{a} ) mod {T}_{SF} ] + [ ( {Δ}_{b , adv} - {r}_{b} ) mod {T}_{SF} ] + k \cdot {T}_{SF} \}$$

where T is the cycle duration applied in the UEs and c is the light speed, and the integer k is adjusted such that d is non-negative and less than c·T_{SF}/2.

The method disclosed in this application is based on the assumption that the timing advance relative to the cycle boundary is not varying during the measurements of transmission and receiving timings that a UE reports to the network node. According to the current LTE specification for D2D, one of the factors that the D2D-capable UE considers in its determination of exact transmission timing is a timing of reference radio frame, which may switch between the timing of downlink radio frame and certain other implicitly derived timing. Such switching is based on one criterion (called S criterion) including a set of Boolean functions associated with received downlink signal strength measurements. For the indoor positioning where the UE location is almost static and the downlink signal strength measurements do not vary much to trigger the changing of Boolean function values in S criterion, the switching between different timings of reference radio frame does not happen during the timing measurements. Therefore the assumption of constant timing advance relative to cycle boundary is fulfilled for the presented method. When the timing of reference radio frame does switch between different timings (e.g. due to channel fading variation for a higher UE moving speed) during the measurements of transmission timing and receiving timings that UE reports, the assumption of constant timing advance no longer holds, and the UE should not report the corresponding timing information to the network. In addition, when this happens, the network should discard the receiving timing information related to the D2D sidelink channel or signal transmitted by this UE and reported by other UEs whose timing of reference radio frame does not switch, because such receiving timing or modulo transmission-to-reception time difference is based on timing measurements of a sidelink channel or signal, for which the assumption of constant timing advance is not fulfilled. In order to allow the network to do so, the UE can attach one or two timestamps to the measured timings in its report, indicating the time instance when the measurements of transmission timing and receiving timing start, and/or the time instance when such measurements end. In some embodiments, the UE may also report to the network the timestamps for the instance when the timing of reference radio frame switches to different value.

In some embodiments, the above described methods and their variations may be implemented as computer software or firmware instructions distributed in a wireless telecommunication system 10 as shown in FIG. 3. Such instructions may be stored in an article with one or more machine-readable storage devices connected to one or more computers or integrated circuits or digital processors such as digital signal processors and microprocessors. In a communication system of 3GPP LTE, the claimed method and related operation process may be implemented in form of software instructions or firmware instructions for execution by a processor in the transmitter and receiver or the transmission and reception controller. In operation, the instructions are executed by one or more processors to cause the transmitter and receiver or the transmission and reception controller to perform the described functions and operations.

What is claimed is:

1. A method for measuring UE-to-UE distance between two UEs based on D2D sidelink channel or signal, comprising:
the network configuring each of the two UEs to perform both transmissions and receptions of the D2D sidelink channel or signal;
the two UEs determining in time domain their respective cycle boundaries of the same cycle duration;
each UE using a corresponding cycle boundary as the timing reference to measure the transmission timing in the transmission of the D2D sidelink channel or signal;
each UE using a corresponding cycle boundary as the timing reference to measure the receiving timing in the reception of the D2D sidelink channel or signal;
each UE reporting to the network one transmission timing that is associated with the transmitted D2D sidelink channel or signal and one or more receiving timings each of which is associated with a received D2D sidelink channel or signal, or reporting to the network one or more modulo transmission-to-reception time differences each of which is associated with a received D2D sidelink channel or signal;
each UE reporting to the network one transmission identity that is associated with the transmitted D2D sidelink channel or signal, and one or more transmission identities each of which is associated with a received D2D sidelink channel or signal; and
the network using the reported timing information with the matched transmission identities to calculate the UE-to-UE distance.

2. The method according to claim 1, wherein the D2D sidelink channel or signal is Physical Sidelink Discovery Channel (PSDCH).

3. The method according to claim 1, wherein the cycle boundary is a subframe boundary and cycle duration is a subframe duration.

4. The method according to claim 1, wherein the transmission timing is a timing advance that is measured as a time interval between the transmission instance at which the D2D sidelink channel or signal is transmitted and a first cycle boundary after the transmission instance.

5. The method according to claim 1, wherein the receiving timing is measured as a time interval between the reception instance at which the D2D sidelink channel or signal is received and a first cycle boundary after the reception instance.

6. The method according to claim 1, wherein the modulo transmission-to-reception time difference equals to the difference between transmission timing and receiving timing, where the difference is in modulo of the cycle duration.

7. The method according to claim 1, wherein the transmission identity is the identity of the UE transmitting the D2D sidelink channel or signal.

8. The method according to claim 1, wherein the transmission identity is the configuration information or an identification number associated with the configuration information that relates to the transmission of D2D sidelink channel or signal.

9. The method according to claim 8, wherein the configuration information indicates the OFDM resources within which the D2D sidelink channel or signal can be transmitted.

10. The method according to claim 1, wherein the network obtains the timing information from UE's reports such that the transmission identity associated with the D2D sidelink channel or signal upon which the receiving timing is reported by any one of the two UEs matches with the transmission identity associated with the D2D sidelink channel or signal upon which the transmission timing is reported by the other of the two UEs.

11. The method according to claim 1, wherein the network obtains the timing information from UE's reports such that the transmission identity associated with the received D2D sidelink channel or signal upon which the modulo transmission-to-reception time difference is reported by any one of the two UEs matches with the transmission identity associated with the D2D sidelink channel or signal that is transmitted by the other of the two UEs.

12. The method according to claim 1, wherein the network calculates the UE-to-UE distance as:
$$d = \frac{c}{2} ( {Δ}_{a , adv} + {Δ}_{b , adv} - {r}_{a} - {r}_{b} + k \cdot {T}_{SF} )$$
where T_{cycle} is the cycle duration, c is the light speed, Δ_{a,adv} and Δ_{b,adv} are reported transmission timings, rₐ and r_{b} are reported receiving timings, and integer k is chosen such that d is non-negative and less than c·T_{cycle}/2.

13. The method according to claim 1, wherein the network calculates the UE-to-UE distance as:
$$d = \frac{c}{2} \{ [ ( {Δ}_{a , adv} - {r}_{a} ) mod {T}_{SF} ] + [ ( {Δ}_{b , adv} - {r}_{b} ) mod {T}_{SF} ] + k \cdot {T}_{SF} \}$$
where T_{cycle} is the cycle duration, c is the light speed, (Δ_{a,adv}−rₐ)mod T_{SF} and (Δ_{b,adv}−r_{b})mod T_{SF} are the reported modulo transmission-to-reception time differences, and integer k is chosen such that d is non-negative and less than c·T_{cycle}/2.

14. The method according to claim 1, where the UE attaches one or more time-stamps to the timing report, indicating the time instance when the measurements of transmission timing and receiving timings used to create the report start, and/or the time instance when such measurements end.

15. The method according to claim 14, where the UE reports to the network the time-stamp for the instance when the timing of reference radio frame is switched to a different value.

16. The method according to claim 1, where the network is the network node where the UE-to-UE distance is calculated.
